(19) United States
(12) Patent Application Publication
(10) Pub. No.: US 2007/0002144 A1
(43) Pub. Date: Jan. 4, 2007

(54) Image capturing system and method of recording progress information of program

(76) Inventors: Keiichi Tsuchida, Fuchu-shi (JP); Kazuo Mikami, Iruma-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/455,261

(22) Filed: Jun. 16, 2006

(30) Foreign Application Priority Data
Jun. 21, 2005 (JP) 2005-180634

(51) Int. Cl. H04N 5/225

(52) U.S. Cl. 348/207.1

(57) ABSTRACT

An image capturing system comprises an image capturing terminal and a host computer. The image capturing terminal includes an image capturing section configured to capture images, an image data processor configured to generate image data according to the data obtained from the image capturing section, a receiver configured to receive progress information describing a progress of a predetermined program transmitted from the host computer, and a recorder configured to record the progress information received by the receiver in a recording medium. The host computer includes a progress information generator configured to generate the progress information, and a transmitter configured to transmit the progress information generated by the progress information generator. The recorder is configured to record the progress information at the time of capturing an image by the image capturing section in the recording medium, relating it to the image data generated by the image data processor.

### CROSS-REFERENCE TO RELATED APPLICATIONS

This application is based upon and claims the benefit of priority from prior Japanese Patent Application No. 2005-180634, filed Jun. 21, 2005, the entire contents of which are incorporated herein by reference.

### BACKGROUND OF THE INVENTION

1. Field of the Invention

This invention relates to an image capturing system comprising an image capturing terminal and a host and a method of recording progress information of a program by such a system.

2. Description of the Related Art

Jpn. Pat. Appln. Publication No. 2004-221665 discloses an image capturing apparatus that can store clock time when a predetermined action is taken as a clock time mark and display game time and progress time by displaying the difference between the image capturing clock time and the clock time mark.

Jpn. Pat. Appln. Publication No. 2002-268806 discloses a sporting game real-time progress details recording system for centrally managing information relating to the progress of a sporting game and the play of each of the players of the game and presenting it to third parties. With such a system, a reporter in the field of the game transmits information relating to the progress of the game to a center and the center centrally manages the information and provides it to third parties.

Jpn. Pat. Appln. Publication No. 9-134323 discloses a game information communication processing system adapted to store the game information input at a game information recording terminal in a database server and display and print out the game information recorded in the database server at a game information output terminal. With such a system, it is possible to print and output game information in a predetermined format only by character codes.

### BRIEF SUMMARY OF THE INVENTION

According to a first aspect of the present invention, there is provided an image capturing system comprising:

an image capturing terminal configured to capture images; and

a host computer communicable with the image capturing terminal,

the image capturing terminal including:
an image capturing section configured to capture images;
an image data processor configured to generate image data according to the data obtained from the image capturing section;
a receiver configured to receive progress information describing a progress of a predetermined program transmitted from the host computer; and
a recorder configured to record the progress information received by the receiver in a recording medium,

the host computer including:
a progress information generator configured to generate the progress information; and
a transmitter configured to transmit the progress information generated by the progress information generator, and

the recorder of the image capturing terminal being configured to record the progress information at the time of capturing an image by the image capturing section in the recording medium, relating it to the image data generated by the image data processor.

According to a second aspect of the present invention, there is provided a progress information recording method of a program by an image capturing system comprising an image capturing terminal and a host computer, the method comprising:

generating progress information of the program by the host computer;

transmitting the progress information from the host computer;

capturing image data relating to the program by the image capturing terminal;

receiving the progress information transmitted from the host computer by the image capturing terminal; and

recording the received progress information by relating to the captured image data by the image capturing terminal.

According to a third aspect of the present invention, there is provided an image capturing system, comprising:

an image capturing terminal configured to capture images; and

a host computer communicable with the image capturing terminal,

the image capturing terminal including:
an image capturing section configured to capture images;
an image data processor configured to generate image data according to the data obtained from the image capturing section;
a time data processor configured to generate image capturing time data relating to the time of capturing an image by the image capturing section;
a recorder configured to record an image file in a state where the image data generated by the image data processor and the image capturing time data generated by the time data processor are related to each other with a predetermined file name in a recording medium; and
an image capturing terminal transmitter configured to transmit captured image information including at least the image capturing time data generated by the time data processor and information relating the file name of the image file recorded in the recording medium,

the host computer including:
a progress information generator configured to generate progress information relating to the progress of a predetermined program;
a host computer receiver configured to receive the captured image information transmitted from the image capturing terminal transmitter; and
a host computer transmitter configured to transmit progress information at the time corresponding to the image capturing time data included in the captured image information as received by the host computer receiver, relating it to the captured image information,

the image capturing terminal further including an image capturing terminal receiver configured to receive the progress information transmitted from the host computer transmitter, and

the recorder of the image capturing terminal being configured to record the image file in the recording medium, relating it to the progress information as received by the image capturing terminal receiver.

According to a fourth aspect of the present invention, there is provided a progress information recording method of a program by an image capturing system comprising an image capturing terminal and a host computer, the method comprising:

the following to be carried out by the image capturing terminal:
capturing image data relating to the program;
transmitting image information relating to the image data to the host computer;
receiving the progress information relating to the progress of the program as transmitted from the host computer;
receiving the image authentication information as transmitted from the host computer; and
recording the image data with the received progress information and the received image authentication information added thereto; and

the following to be carried out by the host computer:
generating progress information of the program;
transmitting the progress information to the image capturing terminal;
receiving the image information as transmitted from the image capturing terminal;
generating image authentication information relating to the received image information; and
transmitting the image authentication information to the image capturing terminal.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram of one embodiment of image capturing system according to the present invention;

FIG. 2 is a basic flowchart of the operation of the one embodiment of image capturing system according to the present invention;

FIG. 3 is a schematic illustration of the configuration of the first specific example;

FIG. 4 is a schematic block diagram of a camera;

FIG. 5 is a main flowchart of the operation of the first specific example;

FIG. 6 is a detailed flowchart of the registration process in FIG. 5;

FIG. 7 is a detailed flowchart of the information format transmission process in FIG. 5;

FIG. 8 is a schematic illustration of the contents of a game progress information file;

FIG. 9 is a schematic illustration of the format of a camera number;

FIG. 10 is a schematic illustration of the format of a game recognition number;

FIG. 11 is a detailed flowchart of the game start signal transmission process in FIG. 5;

FIG. 12A is a display example of the camera before the start of a game;

FIG. 12B is a display example of the camera during a game;

FIG. 13 is a detailed flowchart of the progress information/contents update process in FIG. 5;

FIG. 14 is a schematic illustration of the format of game information;

FIG. 15 is a detailed flowchart of the captured image information transmission process in FIG. 5;

FIG. 16A is a schematic illustration of the format of an image file in an image capturing operation;

FIG. 16B is a schematic illustration of the format of the image file after image authentication information is embedded;

FIG. 17 is a schematic illustration of the format of an image file list;

FIG. 18 is a detailed flowchart of the authentication information sending process in FIG. 5;

FIG. 19 is a detailed flowchart of the authentication information pasting process in FIG. 5;

FIG. 20 is schematic illustration of an example of form of reproduction of an image file where image authentication information is embedded;

FIG. 21 is a schematic illustration of another example of form of reproduction of an image file where image authentication information is embedded;

FIG. 22A is a schematic illustration of still another example of form of reproduction of an image file where image authentication information is embedded;

FIG. 22B is a schematic illustration of still another example of form of reproduction of an image file where image authentication information is embedded;

FIG. 23 is a schematic illustration of an example of form of reproduction of recorded image data for a thumbnail;

FIG. 24 is a schematic illustration of the configuration of the second specific example;

FIG. 25 is a main flowchart of the operation of the second specific example;

FIG. 26 is a schematic illustration of the configuration of the third specific example; and

FIG. 27 is a main flowchart of the operation of the third specific example.

### DETAILED DESCRIPTION OF THE INVENTION

Now, the present invention will be described by referring to the accompanying drawings that illustrate the best mode of carrying out the present invention.

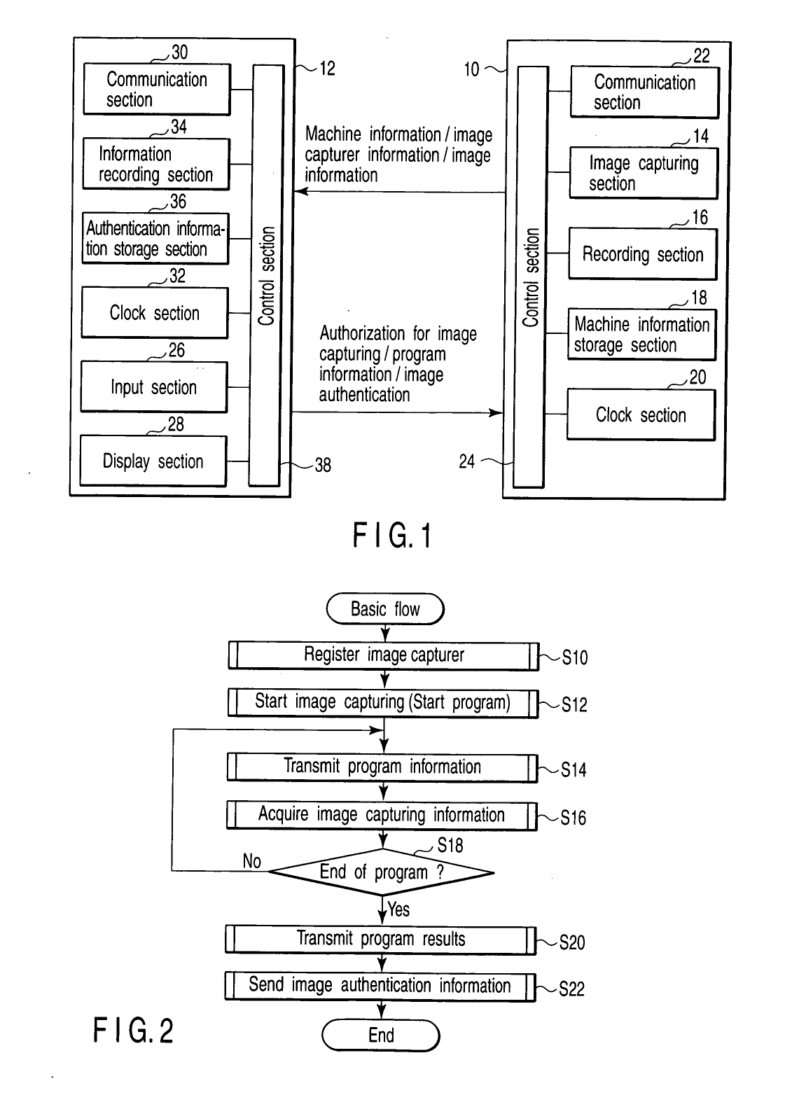

Referring to FIG. 1, an embodiment of image capturing system according to the present invention comprises an image capturing terminal 10 and a host 12. The image capturing terminal 10 is a terminal to be held by an image capturer who captures photographic images of any of various programs, including games, entertainment shows, performances, amusement shows and so on at the site of any programs. The host 12 is a computer arranged on the site of the event so as to be communicable with the image capturing terminal 10. While a single image capturing terminal 10 is representatively shown in FIG. 1, an image capturing system according to the present invention may comprise a plurality of image capturing terminals. In other words, a single image capturer may hold a plurality of image capturing terminals or a plurality of image capturers may hold respective image capturing terminals.

The image capturing terminal 10 comprises an image capturing section 14, a recording section 16, a machine information storage section 18, a clock section 20, a communication section 22 and a control section 24. The image capturing section 14 captures images. The recording section 16 records the image data obtained by the image capturing operation of the image capturing section 14 in a predetermined recording medium. The recording medium may be a memory device that can be removably fitted to the image capturing terminal 10 such as a memory card or one that is contained in the image capturing terminal 10. The machine information storage section 18 stores machine information necessary for identifying the image capturing terminal 10. The clock section 20 measures and indicates time. The communication section 22 communicates with the host 12 typically by way of a wireless LAN. The control section 24 controls the entire image capturing terminal 10.

The host 12 includes an input section 26, a display section 28, a communication section 30, a clock section 32, an information recording section 34, an authentication information storage section 36 and a control section 38. The input section 26 is a user interface, which may be a keyboard, a pointing device or the like. The display section 28 includes a user interface such as a CRT or a liquid crystal display and an electric billboard or some other large display screen arranged on the site of the program, which may be a sports arena. The communication section 30 communicates with the image capturing terminal 10 typically by way of a wireless LAN. The clock section 32 measures and indicates time. The information recording section 34 stores the information transmitted from the image capturing terminal or terminals 10. The authentication information storage section 36 stores authentication information. The control section 38 controls the entire host 12.

Now, referring to FIG. 2, the image capturing system having the above-described configuration firstly registers the image capturer (Step S10). More specifically, the image capturing terminal 10 transmits the machine information stored in the machine information storage section 18 and the information on the image capturer input by way of an input section (not shown) and the host 12 stores those pieces of information in the information recording section 34. Then, in response, the host 12 transmits permission for an image capturing operation to the image capturing terminal 10.

As the scheduled program starts, the image capturing terminal 10 is started capturing operation of images by the image capturer (Step S12). More specifically, the start of the program is input by the input section 26 of the host 12 and the clock section 32 starts measuring the time elapsed from the start of the program. The time measured by the clock section 32 is the official time. Then, the host 12 transmits the program information to the image capturing terminal 10 (Step S14). The program information includes a start signal for the clock section 20 of the image capturing terminal 10, which is a synchronizing signal that makes the clock section 32 of the host 12 and the clock section 20 of the image capturing terminal 10 start timing synchronously. The above-described program information includes the elapsed time from the start of the program to the time when some event such as scoring occurs as measured by the clock section 32 and details of the occurred event. The control section 38 of the host 12 records to the information recording section 34 the elapsed time from the start of the program to the time when the event occurs as measured by the clock section 32 and details of the occurred event as progress information. Upon receiving the program information transmitted from the host 12 at the communication section 22, the control section 24 of the image capturing terminal 10 records it in the recording medium by the recording section 16.

Each time the image capturing terminal 10 performs an image capturing operation, an image capturing information acquisition process is executed (Step S16). This is a process where image capturing information is transmitted from the image capturing terminal 10 to the host 12 and recorded in the information recording section 34 of the host 12 each time an image capturing operation is performed. More specifically, the control section 24 of the image capturing terminal 10 generates image data according to the data obtained by the image capturing operation of the image capturing section 14. Additionally, the control section 24 generates image capturing time data relating to the clock time when the image capturing operation is performed according to the time information obtained as a result of the timing operation of the clock section 20. Then, the control section 24 records an image file where the image data and the image capturing time data that are generated are related to each other with a predetermined file name in the recording medium by the recording section 16. Then, the control section 24 transmits image capturing information including at least the image capturing time data and information relating to the file name of the image file to the host 12 by the communication section 22.

The above-described process of transmitting the program information (Step S14) and the process of acquiring the image capturing information (Step S16) are repeated until a directive for the end of the program is issued by the input section 26 of the host 12 (Step S18).

Then, as a directive for the end of the program is issued, a program result transmission process is executed (Step S20). More specifically, if the program is a sporting game, the control section 38 of the host 12 transmits, by the communication section 30, information on the results of the game including the winner, the loser, the scores and the duration of the game along with progress information as described above that corresponds to the time points when the image capturing time data contained in the image capturing information transmitted from the image capturing terminal 10 and recorded in the information recording section 34, relating the progress information to the image capturing information. Then, the control section 24 of the image capturing terminal 10 records the progress information in the corresponding image file recorded in the recording medium, relating it to the corresponding image file.

After the end of the program result transmission process, an image authentication information sending process is executed (Step S22). More specifically, the control section 38 of the host 12 transmits the authentication information stored in the authentication information storage section 36 to the image capturing terminal 10 by the communication section 30. The control section 24 of the image capturing terminal 10 embeds the authentication information received by way of the communication section 22 in the corresponding image file or in each of the corresponding image files, if more than one image files are made, recorded in the recording medium as an electronic watermark. With this arrangement, it is possible to prevent illegal copying of the image file or each of the image files.

Note that the authentication information is input by way of the input section 26 of the host 12 and stored in the authentication information storage section 36. The authentication information includes the period of authentication, the name of the copyright holder, the organization, the copyright mark and so on. The period of authentication is information indicating (1) the date of expiration of the authentication, (2) the date when the authentication becomes effective, (3) prohibition of unauthorized use and so on.

As described above, this embodiment of image capturing system according to the present invention makes it possible to record captured images of a program, relating them to the respective elapsed times and other information with ease.

Now, the present invention will be described further by way of specific programs.

### FIRST SPECIFIC EXAMPLE

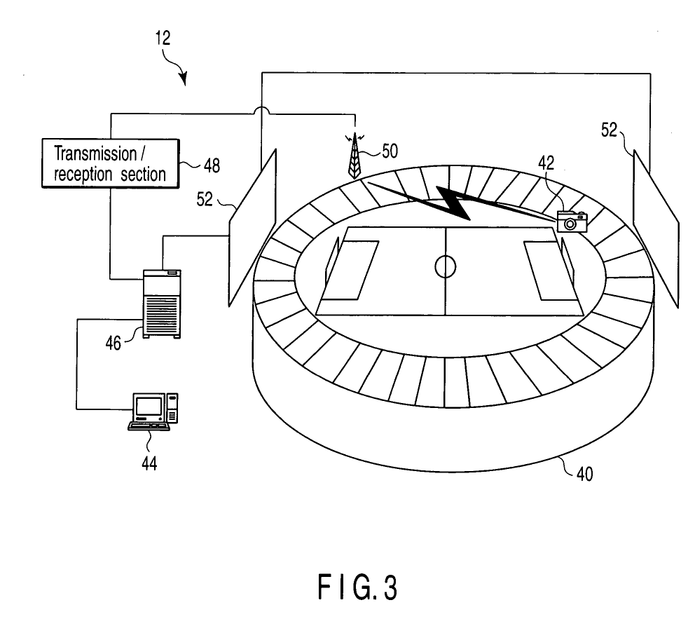

In this example, the embodiment of image capturing system is applied to a soccer game, which is a program to be imaged. Referring to FIG. 3, the host 12 is arranged in the soccer stadium 40. The image capturer holds the image capturing terminal 10, which is a camera 42, and captures photographic images from any of the seats for spectators and those for reporters. The host 12 includes an input terminal 44, a host computer 46, a transmission/reception section 48 and an antenna 50. The input terminal 44 corresponds to part of the input section 26 and the display section 28. The host computer 46 corresponds to the clock section 32, the information recording section 34, the authentication information storage section 36 and the control section 38. The transmission/reception section 48 and the antenna 50 correspond to the communication section 30. The antenna 50 and a large display screen 52 that corresponds to part of the display section 28 are arranged in the stadium 40. Note, however, that the input terminal 44, the host computer 46 and the transmission/reception section 48 do not necessarily need to be arranged in the stadium 40 and may alternatively be arranged at a remote site so long as they are connected to the antenna 50 and/or the large display screen 52.

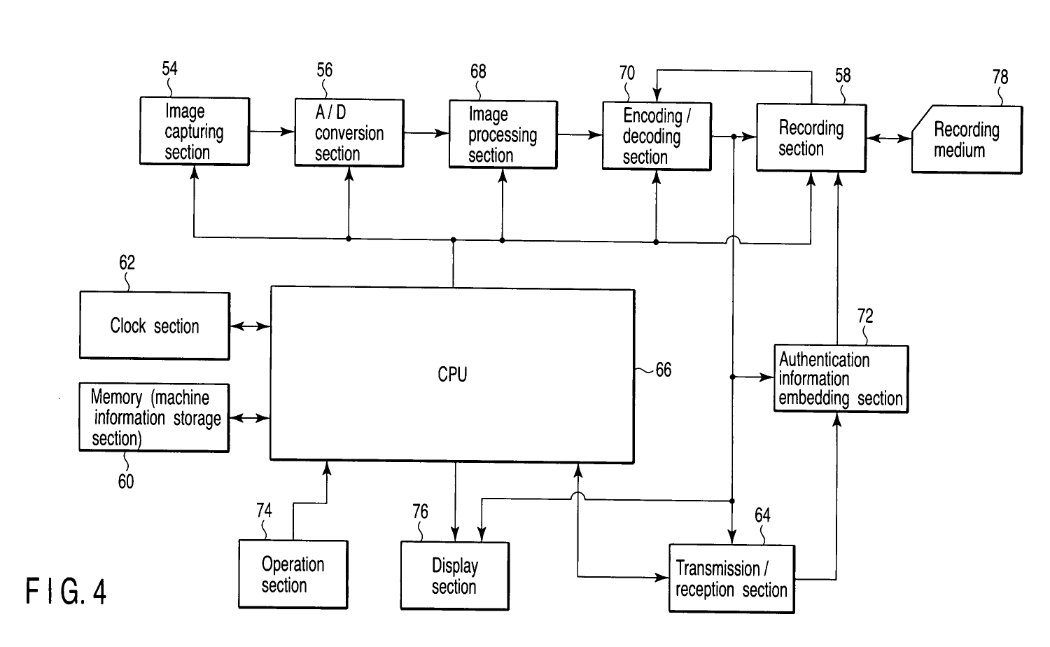

As shown in FIG. 4, the camera 42 has an image capturing section 54, an A/D conversion section 56, a recording section 58, a memory (machine information storage section) 60, a clock section 62, a transmission/reception section 64, a CPU 66, an image processing section 68, an encoding/decoding section 70, an authentication information embedding section 72, an operation section 74 and a display section 76. The image capturing section 54 and the A/D conversion section 56 correspond to the image capturing section 14. The recording section 58 corresponds to the recording section 16 and records various data in a recording medium 78 that can be removably fitted to the camera 42. The memory 60, the clock section 62, the transmission/reception section 64 and the CPU 66 correspond respectively to the machine information storage section 18, the clock section 20, the communication section 22 and the control section 24.

The operation section 74 is operated by the image capturer to issue various directives to the camera 42 for the operation thereof. It includes various buttons and keys such as a release button, a power button, a mode key and a so-called cross key. A personal computer (not shown) may be connected to the camera 42 so that the image capturer operates the keyboard and other input means of the personal computer to issue various directives to the camera 42. The display section 76 includes a liquid display and an viewfinder-display member for displaying the operation mode and the operating condition of the camera 42, the captured images, and so on.

The image capturing section 54 includes an optical system and an image pickup element and is adapted to capture various images under the control of the CPU 66 in response to an operation of the release button of the operation section 74. The captured image is converted into digital data by the A/D conversion section 56 and subsequently subjected to known various image processing operations including white balance correction, tone correction and color correction by the image processing section 68. Then, the digital data are further subjected to an image encoding (compression) process by the encoding/decoding section 70, using a known compression method such as the JPEG method. The JPEG data obtained by the JPEG compression method are recorded in recording medium 78 as JPEG file to which predetermined header information is added. The image data of the recorded JPEG file can be read out at the recording section 58 and decoded by the encoding/decoding section 70 so as to be displayed on the display section 76 under the control of the CPU 66.

The encoding/decoding section 70 additionally has a functional feature of preparing image data (low resolution image data) for a thumbnail out of the image data that are processed by the image processing section 68. The CPU 66 can display the prepared image data for a thumbnail on the display section 76 and transmit them to the host 12 by the transmission/reception section 64.

The authentication information embedding section 72 has such a functional feature that, when it receives authentication information from the host 12 by way of the transmission/reception section 64, it embeds the received authentication information in the corresponding JPEG file as electronic watermark by the recording section 58.

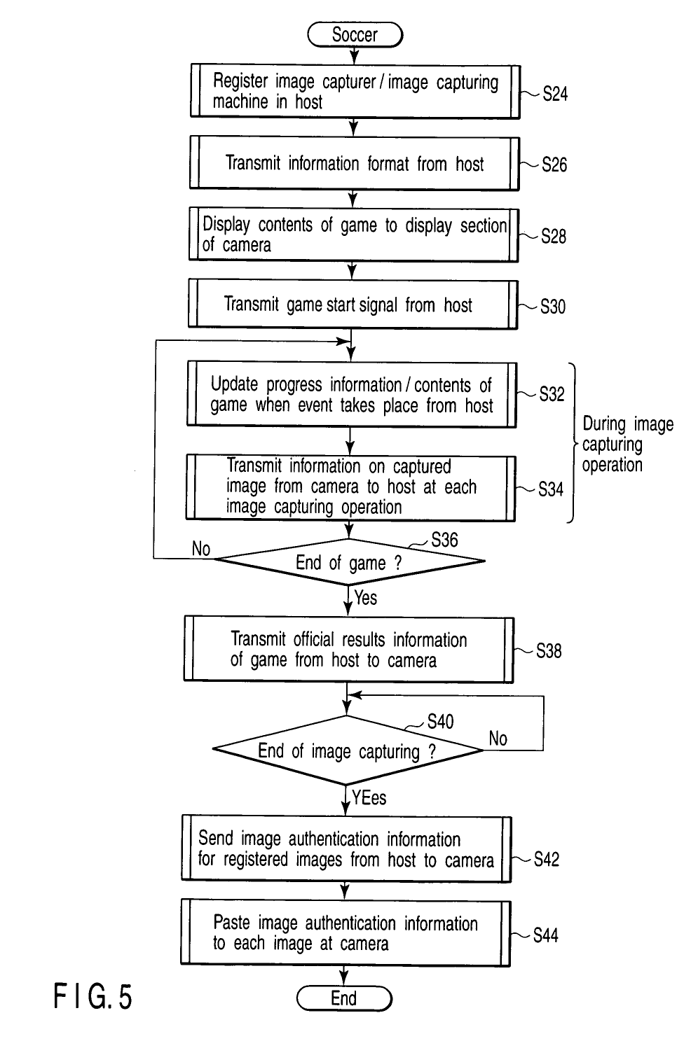

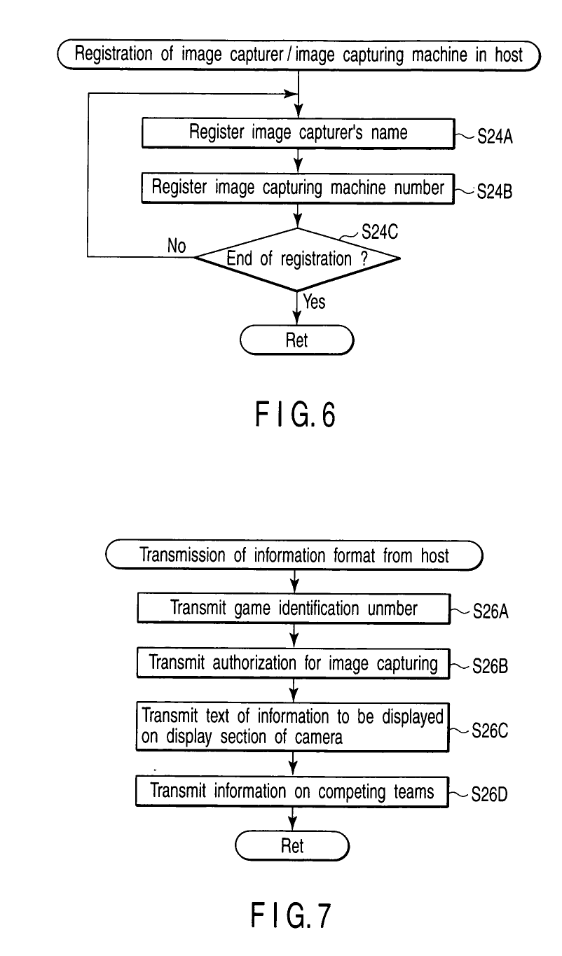

The image capturing system of this first example operates in a manner as described below by referring to the flowchart of FIG. 5. Firstly, a process of registering the image capturer and the image capturing machine or machines in the host 12 is executed (Step S24). In this process, as shown in FIG. 6, the name of the image capturer is registered first (Step S24A). More specifically, the image capturer operates the operation section 74 of the camera 42, which is the image capturing terminal 10, to input his or her own name and transmits to the transmission/reception section 64 as image capturer information. The image capturer information may be stored in the memory 60 of the camera 42 in advance and read out so as to be transmitted. The transmitted image capturer information is received by the transmission/reception section 48 of the host 12 that is connected to the antenna 50 and registered in the host computer 46 (information recording section 34). Thereafter, the machine number or numbers are registered (Step S24B). More specifically, the CPU 66 of the camera 42 reads out the machine information stored in a non-volatile manner in the memory 60 and transmits it by way of the transmission/reception section 64. Then, the transmitted machine information is received by the transmission/reception section 48 of the host 12 that is connected to the antenna 50 and registered in the host computer 46 (information recording section 34). If the image capturer uses a plurality of cameras 42 (that are not registered yet) (Step S24C), the above-described steps S24A, 24B are repeated to register all the remaining cameras 42. The registration process ends when the registration is completed (Step S24C).

Then, a process of transmitting an information format from the host 12 to each of the cameras 42 is executed (Step S26). In this process, the CPU 66 of each of the camera 42 prepares a game progress information file and an image file list according to the information format for the camera 42 that is contained in the information received at the transmission/reception section 64. Then, it records them in the recording medium 78 by the recording section 58 and displays the contents of the game progress information file on the display section 76 (Step S28).

The process of transmitting an information format of the above-described Step S26 is executed in a manner as illustrated in FIG. 7. Referring to FIG. 7, firstly, the host computer 46 transmits the identification number of the game by way of the transmission/reception section 48 and the antenna 50 (Step S26A) and then it transmits permission for image capturing (Step S26B). Thereafter, the host computer 46 transmits the text of the information to be displayed on the display section 76 of the camera 42 (Step S26C). Then, it transmits information on the competing teams (Step S26D) to end the process of transmitting the information format.

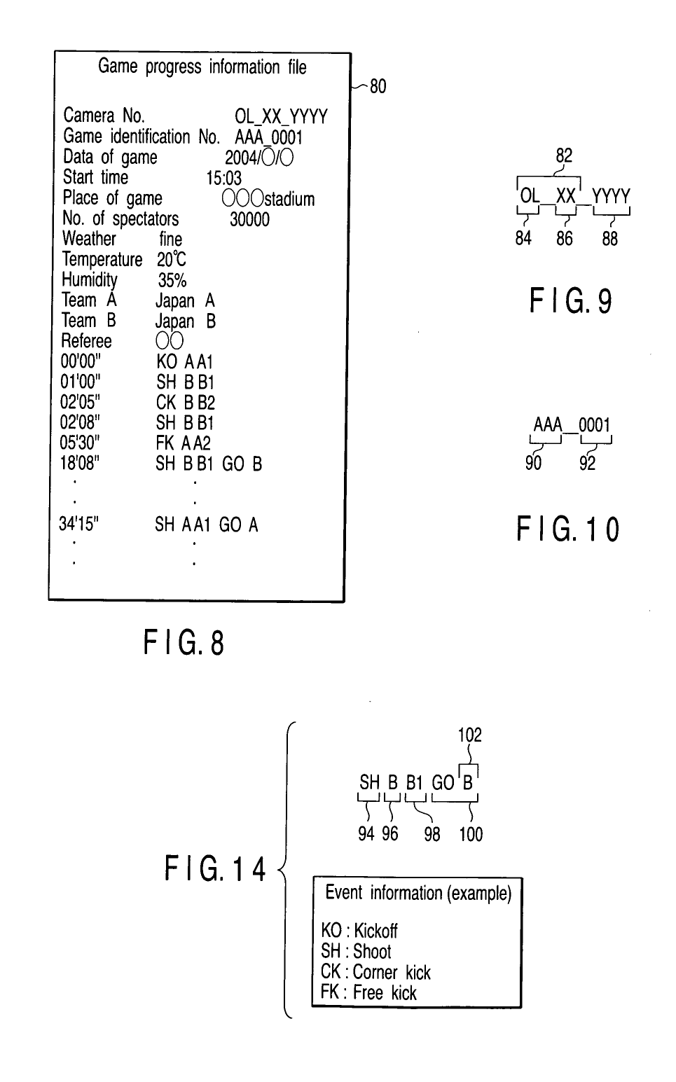

FIG. 8 illustrates a typical game progress information file. Note that the game progress information file 80 of FIG. 8 shows the contents of the file at the time when the game is over. In other words, the columns of “start time”, “number of spectators” and event information are still blank at time point of the Step S28.

“Camera number” in the game progress information file 80 includes image capturing machine information 82 that by turn includes machine manufacturer information 84 and machine name information 86 and image capturer information 88 as shown in FIG. 9. The above listed pieces of information are those registered in the above-described registration process of Step S24 so that the camera 42 can determine if the information transmitted from the host 12 is addressed to the own camera 42 or not by referring to “camera number”.

“Game identification number” includes promoter information 90 and game identification number information 92 as shown in FIG. 10. These pieces of information are those input by way of the input terminal 44 and registered in the host computer 46. They are transmitted in the above-described Step S26A.

Similarly, “date of the game”, “place of the game”, “weather”, “temperature”, “humidity” and other pieces of information are transmitted in the above-described Step S26C whereas “team name A”, “team name B”, “referee” and other pieces of information are transmitted in the above-described Step S26D.

Thus, the processes of Step S24 through Step S28 are executed in the pre-game stages.

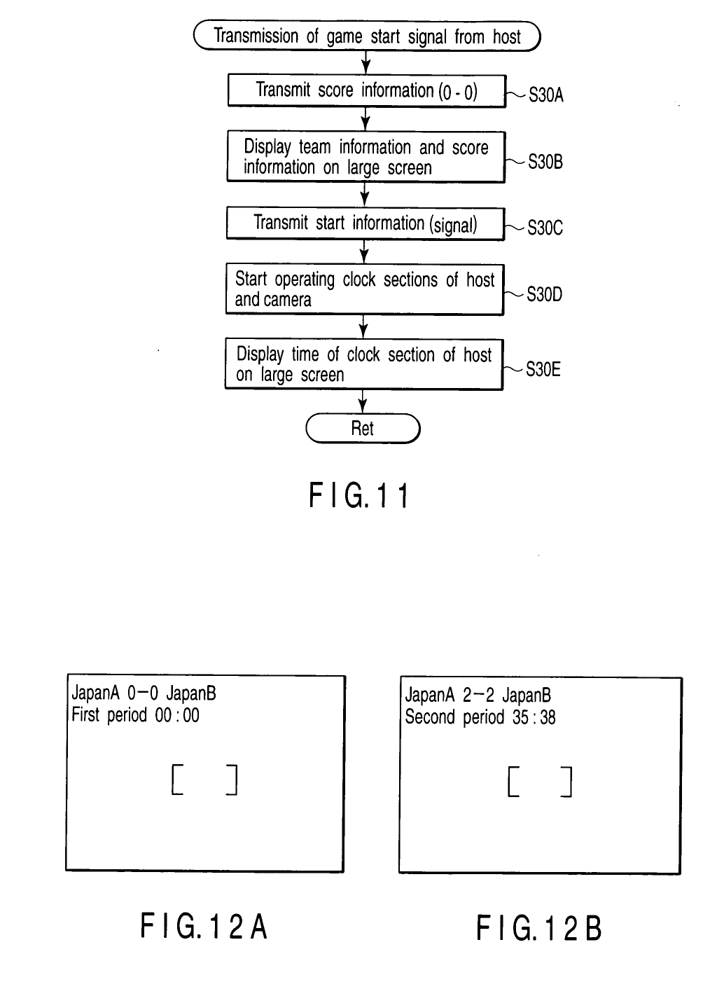

When the game actually starts, the host 12 executes a process of transmitting a game start signal (Step S30). In this game start signal transmission step, as shown in FIG. 11, the host computer 46 firstly transmits score information (0-0) to each of the cameras 42 by way of the transmission/reception section 48 and the antenna 50 (Step S30A). Additionally, it displays team information and score information on the large display screen 52 of the stadium 40 (Step S30B). At this time, each of the cameras 42 displays an image as shown in FIG. 12A on the display section 76 according to the score information and the contents of the game progress information file 80, which are described above. Then, the operator of the host 12 issues a directive for the start of the game by the input terminal 44 at the time of the kickoff of the game. Upon receiving the directive, the host computer 46 transmits a timing start signal to the clock section 32 in or connected to the host computer 46 and timing start information and the current clock time to each of the cameras 42 (Step S30C). As a result, the clock section 32 starts operating and the clock section 62 of each of the cameras 42 also starts operating (Step S30D). Then, each of the cameras 42 sets the “start time” of the above-described game progress information file 80 to the transmitted current clock time and writes down the kickoff as event information. The time as measured by the clock section 32 of the host 12 is the so-called official time and displayed on the large display screen 52 (Step S30E).

Then, a process of updating the contents of the progress information of the game at the time by the host 12 when an event occurs (Step S32) and a process of transmitting information on the image captured by the camera 42 when capturing operation is executed by the camera 42 (Step S34) are repeatedly executed until the game ends (Step S36).

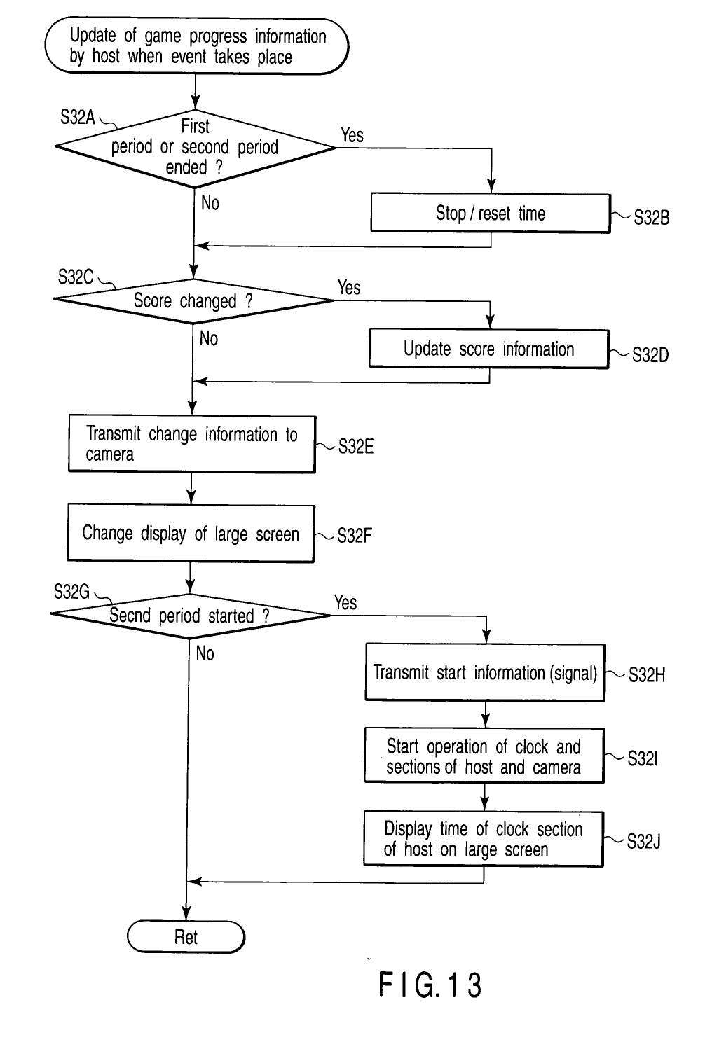

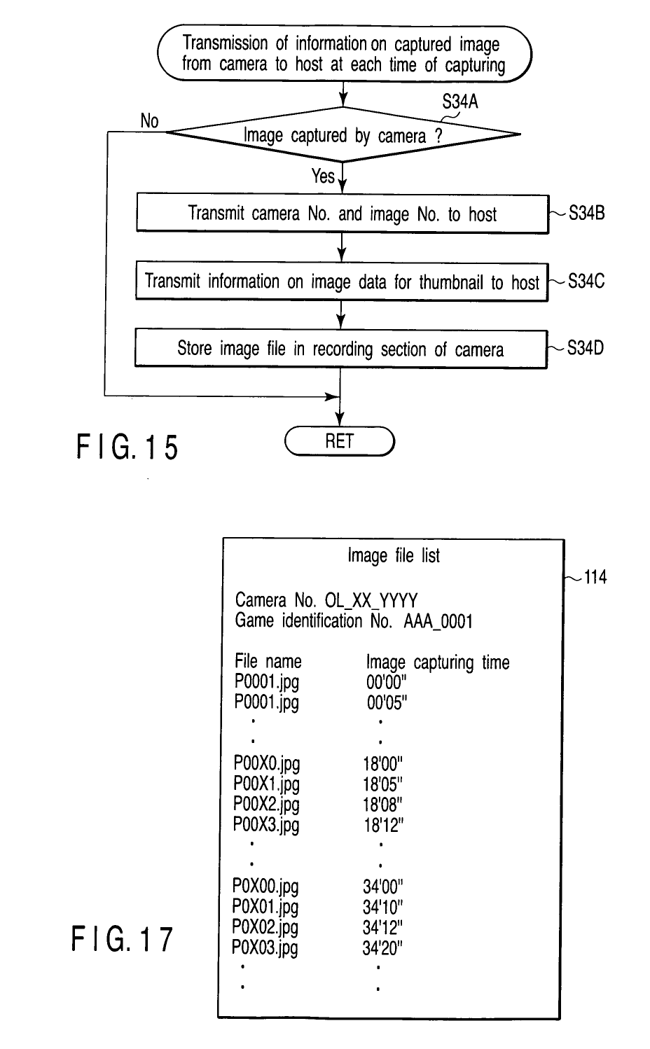

The above-described process of updating the contents of the progress information in Step S32 proceeds in a way as illustrated in FIG. 13. Firstly, the host computer 46 of the host 12 determines if there is a directive for ending the first period half or the second period issued by operating the input terminal 44 or not (Step S32A). If there is such a directive for ending the half, the host computer 46 stops the clock section 32 and resets the timing (Step S32B). Thereafter, or if it is determined that such a directive for ending the half is not issued in the above-described Step S32A, the host computer 46 determines if there is a directive for changing the score issued by operating the input terminal 44 or not (Step S32C). If there is such a directive for changing the score, the host computer 46 updates the score information recorded in the information recording section 34 in the host computer 46 (Step S32D). Thereafter, or if it is determined that such a directive for changing the score is not issued in the above-described Step S32C, the host computer 46 transmits the change information to each of the cameras 42 according to the information recorded in the information recording section 34 in the host computer 46 (Step S32E) and, at the same time, updates the contents of the display on the large display screen 52 (Step S32F). If there is not any event that occurs, the host computer 46 simply transmits the time measured by the clock section 32 in step S32E and only the measured time that is being displayed is updated in Step S32F.

Events as used herein include kickoff, shoot, corner kick, free kick and so on that are described in the form of game information as illustrated in FIG. 14. In other words, game information includes event information 94, team information 96, player information 98 and score information 100 that includes scoring team information 102. The example of FIG. 14 indicates that the shoot of player B1 of team B got the goal and gave a point to team B. For the purpose of discriminating events, a code is assigned to each event as shown in FIG. 14. In the above-described step S32E, game information as illustrated in FIG. 14 is transmitted with the clock time when the event took place as measured by the clock section 32. As a result, each of the cameras 42 that receive the game information and the clock time writes the game information on the event in the game progress information file 80 and, at the same time, updates the image being displayed on the display section 76 from the one illustrated in FIG. 12A to the one illustrated in FIG. 12B. The images as shown in FIGS. 12A and 12B as examples may be displayed on the display section comprising a large liquid crystal display panel or in a finder. Thus, the image capturers can easily grasp the progress of the game as the elapsed time and the score information are displayed in the above-described manner. The CPU 66 of the camera 42 stops the clock section 62 and resets it when the event that takes place is the end of the first period or the second period of the game. The CPU 66 of the camera 42 makes the time being measured by the clock section 62 synchronize with the time received from the host 12 each time it receives it when the event that takes place is not the end of the first period or the second period of the game. Alternatively, it may be so arranged that the CPU 66 of the camera 42 makes the time being measured by the clock section 62 synchronize with the time received from the host 12 not each time it receives but when the difference between the two times show a difference larger than a predetermined value.

After updating the image being displayed on the large display screen 52 in the above-described Step S32F, the host computer 46 of the host 12 determines if there is a directive for starting the second period of the game given by operating the input terminal 44 or not (Step S32G). If it is determined that there is not any directive for starting the second period, the host computer 46 ends the process of updating the progress information. If, on the other hand, it is determined that there is a directive for starting the second period, the host computer 46 transmits a timing start signal to the clock section 32 and, at the same time, timing start information and the current clock time to each of the cameras 42 (Step S32H). As a result, the clock section 32 starts operating and, at the same time, the clock section 62 of each of the cameras 42 also starts operating (Step S32I). Then, the host computer 46 displays the time being measured by the clock section 32 of the host 12 on the large display screen 52 (Step S32J) and ends the process of updating the progress information.

In the process of transmitting information on the image captured by the camera 42 when capturing operation is executed in the above-described Step S34, the CPU 66 of the camera 42 firstly determines if the camera 42 is operating to capture an image or not (Step S34A). If the camera 42 is not operating to capture an image, the CPU 46 does nothing and simply ends the process of transmitting information on the image captured by the camera 42. If, on the other hand, the camera 42 is operating to capture an image, the CPU 66 transmits the camera number stored in the memory 60 in a non-volatile manner and the image number of the captured image (image file name) to the host 12 by way of the transmission/reception section 64 (Step S34B). At the same time, the CPU 46 also transmits the image data to be used for a thumbnail of the captured image to the host 12 in the same way (Step S34C). Then, the CPU 66 records the captured image in the recording medium 78 as image file (Step S34D). Note that the host computer 46 records the image data to be used for a thumbnail received from each of the cameras 42 by way of the antenna 50 and the transmission/reception section 48 in the information recording section 34 in or connected to the host computer 46, relating them to the camera number and the image number (image file name).

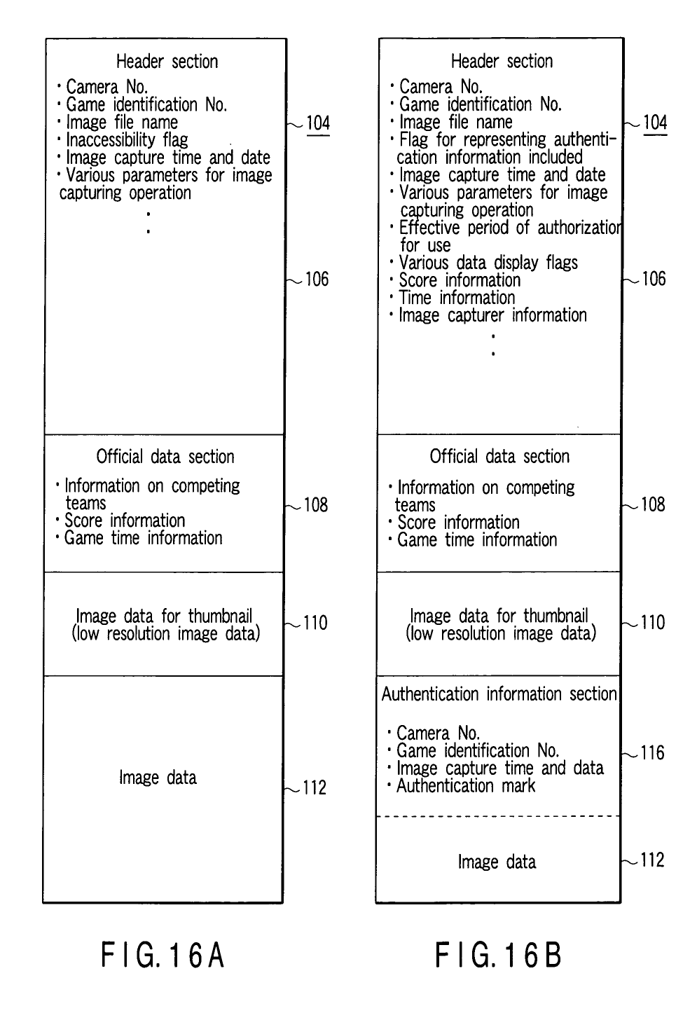

As shown in FIG. 16A, the image file 104 that is recorded in the recording medium 78 of the camera 42 includes a header section 106, an official data section 108, image data to be used for a thumbnail 110 and image data 112. “Camera number”, “game identification number”, “image file name”, “inaccessibility flag”, “image capture time and date”, “various parameters for the image capturing operation” and other data are written in the header section 106. Note that “camera number” is written according to the machine information stored in the memory 60 in a non-volatile manner. “Game identification number” is written according to the game progress information file 80 read out from the recording medium 78 by the recording section 58. “Image file name” is the name of the image file 104. “Inaccessibility flag” is a flag for making the image file 104 inaccessible until image authentication is obtained for the image file as will be described in greater detail hereinafter. However, it may alternatively be so arranged that the image file 104 is not totally inaccessible but accessible for displaying the image data to be used for a thumbnail 110 in order to check the image even when “inaccessibility flag” is set in position. “Image capture time and date” is information obtained from the clock section 62. “Various parameters for the image capturing operation” are Exif information including the aperture and the shutter speed.

The official data section 108 describes “information on the competing teams”, “score information” and “game time information” according to the game progress information file 80 read out from the recording medium 78 by the recording section 58. Note that the data stored in the official data section 108 are described according to the game progress information file 80 that is updated according to the official results information transmitted from the host 12 after the end of the game as will be described in greater detail hereinafter. Therefore, the column of the official data section 108 is left blank in the image file that is stored at the time when the image is captured. The image data to be used for a thumbnail 110 is prepared by the encoding/decoding section 70. The image data 112 are the encoded image data prepared by the encoding/decoding section 70.

The CPU 66 of the camera 42 prepares an image file list 114 as shown in FIG. 17 and stores it in the recording medium 78 by the recording section 58 in response to the reception of the information format transmitted from the host 12 as described above. Then, the CPU 66 of the camera 42 updates the image file list 114 when the image file is recorded in the above-described Step S34D, relating the image file name to the image capture time and date.

In the above-described manner, the game progress information is updated by the host 12 each time an event takes place during the game, which event may be a score, the end of the first period or the end of the half time, and the camera 42 transmits information on the captured image (image data to be used for a thumbnail, the image number, etc.) to the host 12 each time an image is captured.

In this example, only the least information necessary for grasping the progress of the game such as score information and elapsed time information is transmitted while the game is in progress such as during the first period and during the second period and information on all the other events are collectively transmitted after the end of the game. This arrangement is made in order to minimize the traffic between the host 12 and the camera 42 while the game is in progress. With this arrangement, it is possible for the camera 42 to minimize the risk of missing image capturing chances due to communication with the host 12. However, it may be inconvenient if it is not possible for the camera 42 to grasp the progress of the game. Thus, it is so arranged that only the least information on the progress of the game is transmitted while the game is still going on as described above.

While each time the camera 42 captures an image, information on the captured image is transmitted from the camera 42 to the host 12 in this example, the timing of transmission is not limited to such an occasion and all the information on the captured images may be transmitted to the host 12 after the end of the game.

As the operator of the host 12 issues a directive for ending the game by the input terminal 44 (Step S36), the system gets out of the loop of repeating the processes of Steps S32 and S34.

At this time, the host computer 46 executes a process of transmitting official results information of the game to each of the cameras 42 by way of the transmission/reception section 48 and the antenna 50 (Step S38). Upon receiving the official results information, each of the cameras 42 updates the information on the game including “number of spectators”, “final score”, “number of shoots” and “number of corner kicks” in the game progress information file 80 recorded in the recording medium 78 by way of the recording section 58.

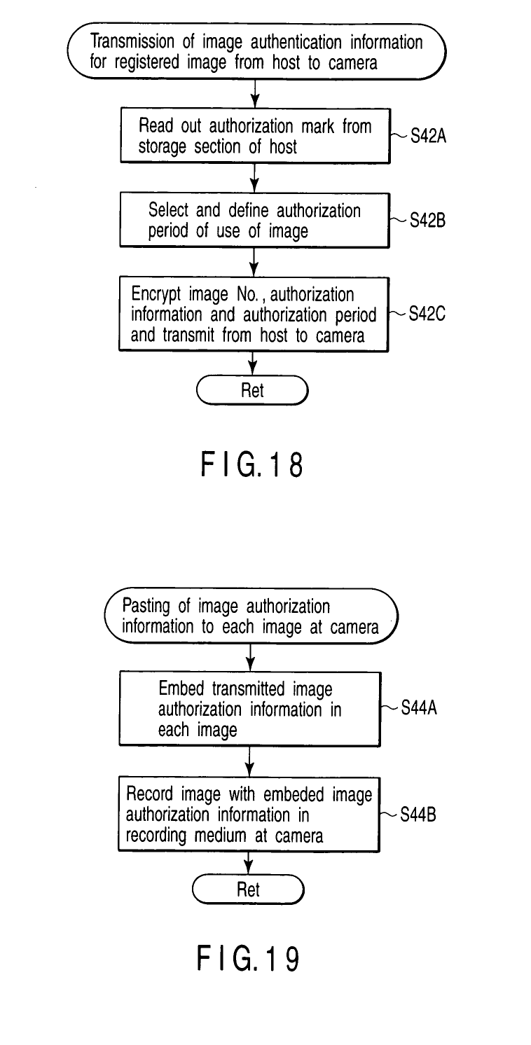

Then, when the image capturing operation of each of the cameras 42 ends (Step S40), the host 12 executes a process of sending authentication information to each of the cameras 42 (Step S42). More specifically, referring to FIG. 18, in this authentication information sending process, the host computer 46 firstly reads out the authorization mark that is authorization information stored in it or in the authentication information storage section 36 connected to it (Step S42A). Subsequently, the operator of the host 12 operates the input terminal 44 to select an authorization period for authorizing the use of each of the recorded images and the host computer 46 defines the authorization period of each of the images accordingly (Step S42B). Then, the host computer 46 transmits the image number, the authorization information and the authorization period of each of the images to each of the cameras 42 as image authentication information by way of the transmission/reception section 48 and the antenna 50 (Step S42C). The image authentication information is preferably encrypted before it is transmitted.

The camera 42 then executes a process of pasting the image authentication information of each of the images to the corresponding one of the images (Step S44). More specifically, in this authentication information pasting process, the authentication information embedding section 72 of the camera 42 embeds the image authentication information of each of the images received by way of the transmission/reception section 64 in the corresponding one of the images read out from the recording medium 78 by the recording section 58 (Step S44A) as shown in FIG. 19. Then, the CPU 66 of the camera 42 records the image file 104 in which the image authentication information is embedded in the recording medium 78 by the recording section 58.

FIG. 16B illustrates the format of the image file in which the image authentication information is embedded. “Use authorization period” that reflects the above-described authorization period contained in the received image authentication information is written in the header section 106 and “inaccessibility flag” is replaced by “flag for representing authentication information included”. While the flags are illustrated in FIGS. 16A and 16B, in reality, a specific bit of the header section is used to indicate “0” or “1”, signifying “inaccessibility flag” or “flag for representing authentication information included”, whichever appropriate. The data of the authentication information section 116 of FIG. 16B is also embedded in the image data 112. The authentication information section 116 contains “camera number”, “game identification number” and “image capture time and date” read out from the game progress information file 80 recorded in the recording medium 78 and “authentication mark” included in the received image authentication information. The header section 106 additionally contains “various data display flags” as well as “score information”, “time information”, “image capturer information” and so on obtained at the time of capturing each of the images contained in the game progress information file 80 recorded in the recording medium 78 and the image file 104 specified out of the image file list.

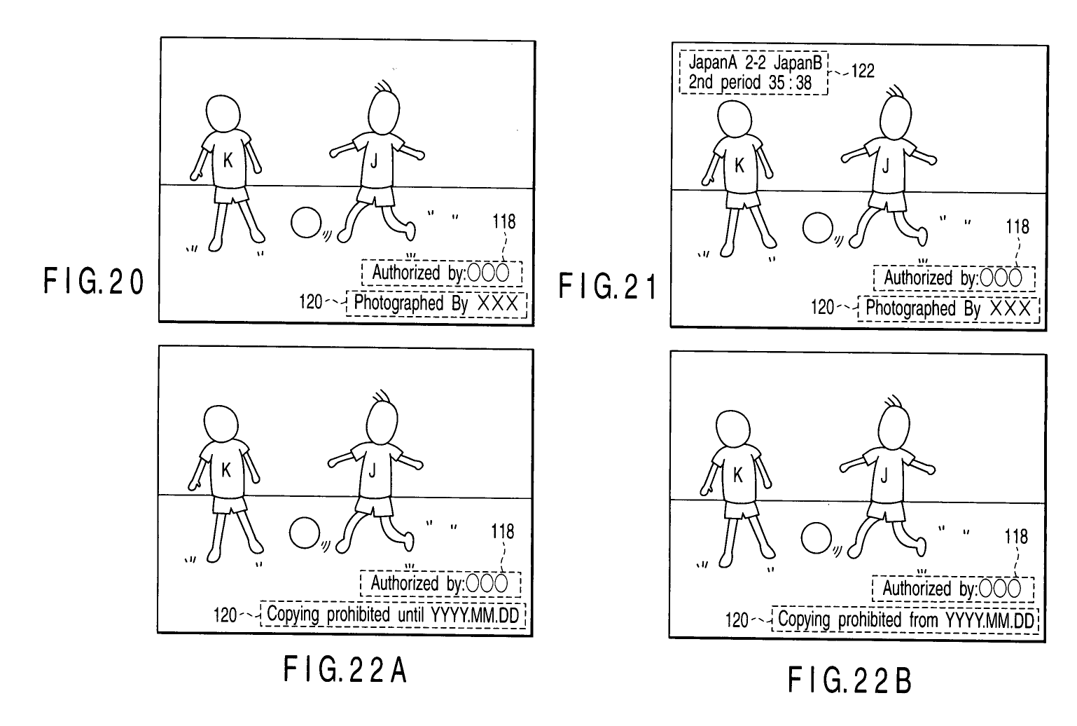

FIG. 20 illustrates how an image is reproduced (for displaying and printing) from the image file 104 where the image authentication information is embedded. The first authentication information display 118 is a display of the authentication mark embedded in the image data, which is reproduced constantly. On the other hand, the second authentication information display 120 is a display of the information embedded in the header section 106. In the instance of FIG. 20, it is a display of “image capturer”. The second authentication information display 120 may be selected arbitrarily for the type of display and also for display/non-display by the user and the outcome of the user selection is described as “various data displaying flags” in the header section. As show in FIG. 21, it is possible to provide a game information display 122. FIGS. 22A and 22B show other examples of the second authentication information display 120.

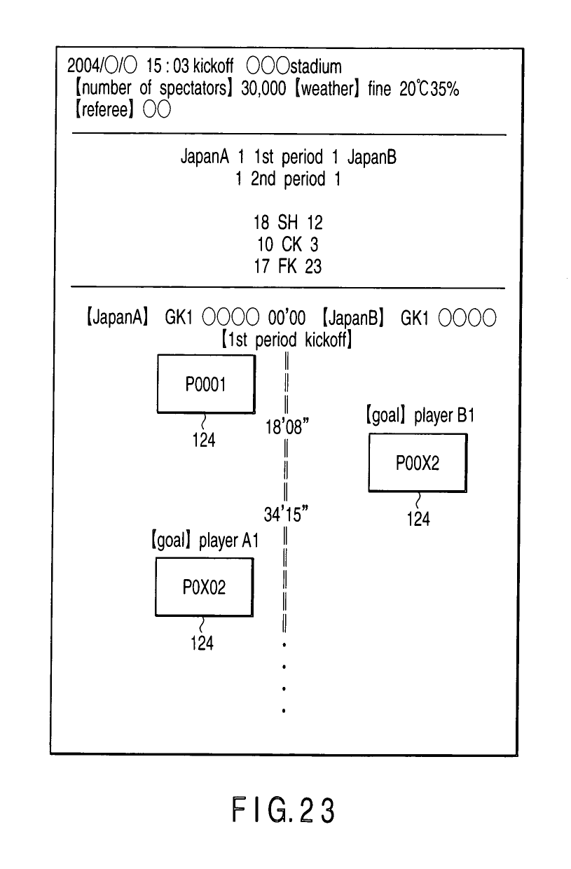

The camera 42 or a reproduction apparatus where the recording medium 78 taken out from the camera 42 is set in position can reproduce data as shown in FIG. 23. In FIG. 23, the image data for thumbnails of the images captured when events took place during the game are arranged in a time series according to the contents of the game progress information file 80 and those of the image file list 114 that are recorded in the recording medium 78 so that the flow of the game may be grasped in a sense of seeing bird's-eye views. As seen from FIG. 23, general information including the time and date of the game, the site of the game and the weather conditions is described in an upper part and the results of the game are described concisely in a middle part. Then, events are described in the order of time series so that the time when each event took place may be realized with ease. Then, the thumbnail image 124 of the image file 104 that is obtained at the time closest to the time when an event took place is arranged at a side of the event. The events may be arranged in such a way that the teams are separated to the right and left sides and each event is assigned to the proper team to facilitate the understanding of the view.

### SECOND SPECIFIC EXAMPLE

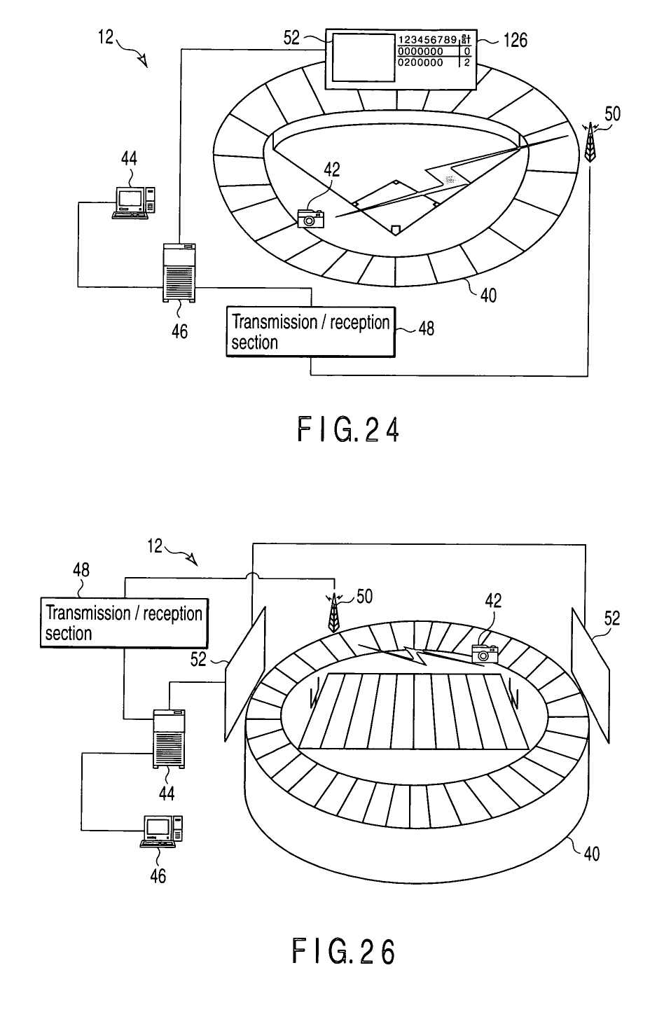

In this example, the embodiment of image capturing system is applied to a baseball game, which is a program to be imaged. As seen from FIG. 24, the configuration of the image capturing system of this second specific example differs from that of the image capturing system of the first specific example only in that the large display screen 52 of the first example is replaced by a scoreboard 126 installed in the stadium 40 of baseball. Of course, a large display screen 52 may also be installed in the stadium 40 in addition to the scoreboard 126. Alternatively the scoreboard 126 may be provided as part of the large display screen 52.

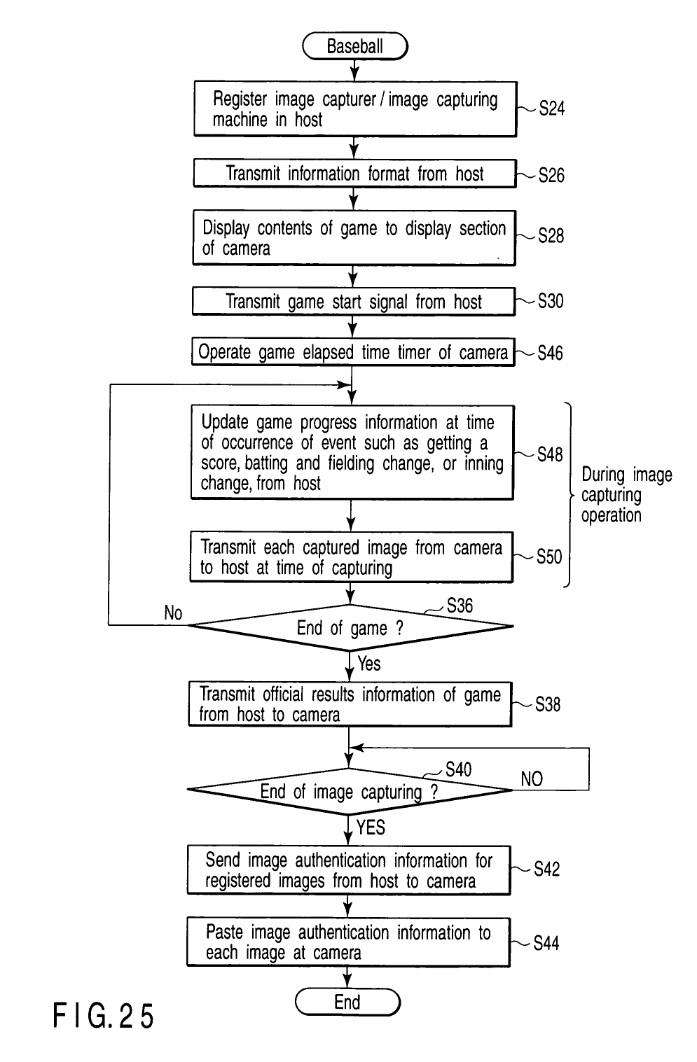

The operation of the image capturing system of this second specific example is also substantially same as that of the first specific example as seen from FIG. 25. Note, however, while the clock section 62 of the camera 42 starts measuring the time elapsed since the start of the game in the process of transmitting a game start signal executed in Step S30 in the above-described first example, it does not start measuring the time elapsed since the start of the game in Step S30 but in Step S46, which is next to Step S30. This is because, unlike a soccer game, it is only necessary for a baseball game to measure the duration of the game from the start to the end of the game and a slight discrepancy of time (of several seconds), if any, does not give rise to any problem.

After the start of the game, the process of updating the game progress information at the time when an event takes place that is executed by the host 12 (Step S48) and the process of transmitting information on the image captured by the camera 42 when the capturing operation is executed by the camera 42 (Step S50) are repeated until the game ends (Step S36).

Events that take place in a baseball game include a score obtained by the scoring team and a change of the side of the batting team and that of the fielding team, which may take place to enter a new inning. Hits, outs, steals and replacements of players may also be treated as events.

Otherwise, this specific example is identical with the first specific example and hence will not be described any further.

### THIRD SPECIFIC EXAMPLE

In this example, the embodiment of image capturing system is applied to an American football game, which is a program to be imaged. As seen from FIG. 26, the configuration of the image capturing system of this third specific example is similar to that of the image capturing system of the first specific example. However, for the operation of capturing images of an American football requires two different types of clocks, one for measuring the elapsed time from the start of the game and the official time that is stopped and restarted intermittently. Therefore, the clock section 32 of the host 12 and the clock section 62 of the camera 42 need to be adapted to measure these two types of time simultaneously.

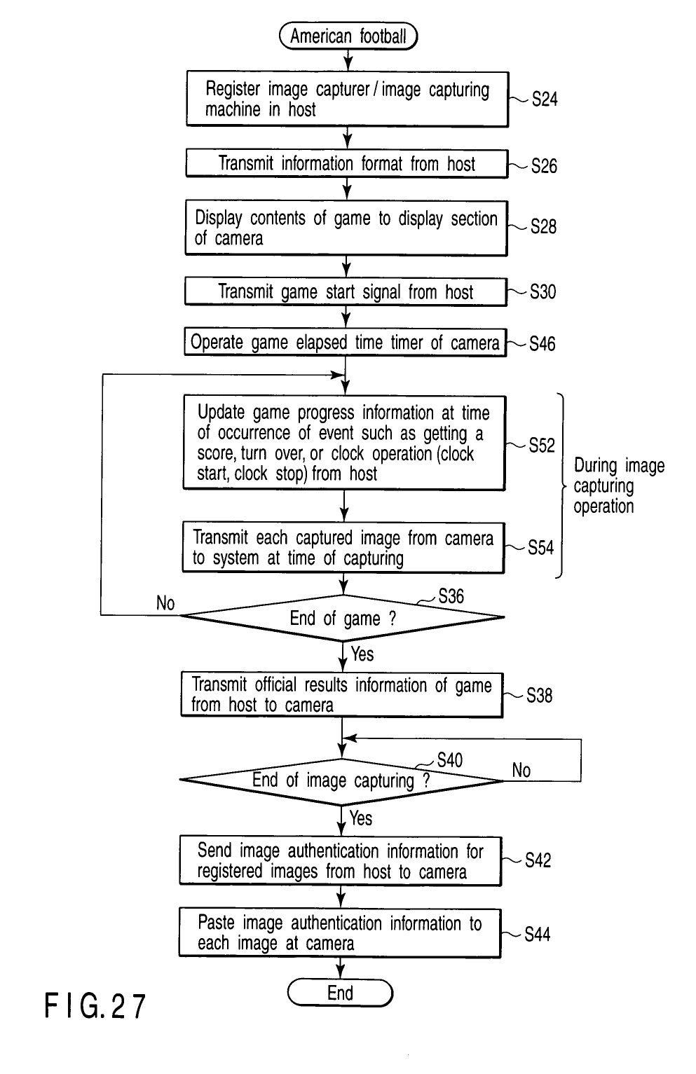

The operation of the image capturing system of this third specific example is substantially same as that of the image capturing system of the second specific example as shown in FIG. 27. However, in this specific example, Step S48 of the second specific example is replaced by Step S52, where a process of updating the game progress information is executed by the host 12 when an event takes place. In the case of an American football game, such an event may be getting a score, turn over or the time of clock operation (starting timing or stopping timing).

Then, in Step S38, a process of transmitting official results information of the game from the host 12 to each of the cameras 42 is executed by the host 12. The official results information includes the elapsed time and the official time.

While the present invention is described by way of an embodiment, the present invention is by no means limited to the above-described embodiment, which may be modified or altered in various different ways without departing from the spirit and scope of the present invention. For example, the progress information may be updated by the host 12 not each time when an event takes place but each time when a predetermined period of time has elapsed. Additionally, the host 12 records the image data for thumbnails and generates image authentication information and the image capturing terminal 10 embeds the image authentication information in the images only for the images captured between the start of a program, which may be a sporting game, and the end of the program in each of the above-described specific examples, similar processes may be executed for the images captured before the start of the program and after the end of the program.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An image capturing system comprising:
an image capturing terminal configured to capture images; and
a host computer communicable with the image capturing terminal,
the image capturing terminal including:
an image capturing section configured to capture images;
an image data processor configured to generate image data according to the data obtained from the image capturing section;
a receiver configured to receive progress information describing a progress of a predetermined program transmitted from the host computer; and
a recorder configured to record the progress information received by the receiver in a recording medium,
the host computer including:
a progress information generator configured to generate the progress information; and
a transmitter configured to transmit the progress information generated by the progress information generator, and
the recorder of the image capturing terminal being configured to record the progress information at the time of capturing an image by the image capturing section in the recording medium, relating it to the image data generated by the image data processor.

2. The image capturing system according to claim 1, wherein
the image capturing terminal further includes an image capturing terminal clock configured to measure time; and
the host computer further includes a host clock configured to measure time and is configured to transmit a synchronizing signal for synchronizing the image capturing terminal clock and the host computer clock to the image capturing terminal by the transmitter in response to the start of the program.

3. The image capturing system according to claim 1, wherein the progress information generator of the host computer is configured to generate progress information at each predetermined clock time.

4. The image capturing system according to claim 1, wherein the progress information generator of the host computer is configured to generate progress information each time when a predetermined event takes place in the program.

5. The image capturing system according to claim 1, wherein the transmitter of the host computer is configured to transmit the progress information at each predetermined clock time.

6. The image capturing system according to claim 1, wherein the transmitter of the host computer is configured to transmit the progress information each time when a predetermined event takes place in the program.

7. The image capturing system according to claim 1, wherein the recorder of the image capturing terminal is configured to record the progress information transmitted from the host computer and received by the receiver in the recording medium at each time of reception thereof.

8. The image capturing system according to claim 2, wherein the host computer is configured to transmit host computer timing information of the host at the time of transmission as timed by the host computer clock by the transmitter when the progress information is transmitted by the transmitter.

9. The image capturing system according to claim 8, wherein the image capturing terminal clock is configured to synchronize terminal timing information thereof as measured by the terminal clock with the host computer timing information transmitted from the host computer when the difference between the host computer timing information and the terminal timing information is larger than a predetermined value.

10. The image capturing system according to claim 8, wherein the image capturing terminal clock of the image capturing terminal is configured to synchronize the terminal timing information thereof as measured by the terminal clock with the host computer timing information transmitted from the host computer each time when the receiver receives the host computer timing information.

11. A progress information recording method of a program by an image capturing system comprising an image capturing terminal and a host computer, the method comprising:
generating progress information of the program by the host computer;
transmitting the progress information from the host computer;
capturing image data relating to the program by the image capturing terminal;
receiving the progress information transmitted from the host computer by the image capturing terminal; and
recording the received progress information by relating to the captured image data by the image capturing terminal.

12. The method according to claim 11, further comprising generating the progress information by the host computer at each predetermined clock time.

13. The method according to claim 11, further comprising generating the progress information by the host computer each time when a predetermined event takes place in the program.

14. The method according to claim 11, further comprising transmitting the progress information by the host computer at each predetermined clock time.

15. The method according to claim 11, further comprising transmitting the progress information by the host computer each time when a predetermined event takes place in the program.

16. An image capturing system, comprising:
an image capturing terminal configured to capture images; and
a host computer communicable with the image capturing terminal,
the image capturing terminal including:
an image capturing section configured to capture images;
an image data processor configured to generate image data according to the data obtained from the image capturing section;
a time data processor configured to generate image capturing time data relating to the time of capturing an image by the image capturing section;
a recorder configured to record an image file in a state where the image data generated by the image data processor and the image capturing time data generated by the time data processor are related to each other with a predetermined file name in a recording medium; and
an image capturing terminal transmitter configured to transmit captured image information including at least the image capturing time data generated by the time data processor and information relating the file name of the image file recorded in the recording medium,
the host computer including:
a progress information generator configured to generate progress information relating to the progress of a predetermined program;
a host computer receiver configured to receive the captured image information transmitted from the image capturing terminal transmitter; and
a host computer transmitter configured to transmit progress information at the time corresponding to the image capturing time data included in the captured image information as received by the host computer receiver, relating it to the captured image information,
the image capturing terminal further including an image capturing terminal receiver configured to receive the progress information transmitted from the host computer transmitter, and
the recorder of the image capturing terminal being configured to record the image file in the recording medium, relating it to the progress information as received by the image capturing terminal receiver.

17. The image capturing system according to claim 16, wherein the host computer is configured to transmit image authentication information to the image capturing terminal by the host computer transmitter.

18. The image capturing system according to claim 17, wherein
the image capturing terminal receiver is configured to receive the image authentication information transmitted from the host computer, and
the image capturing terminal is configured to add the received image authentication information to the image file.

19. The image capturing system according to claim 18, wherein the image capturing terminal is configured to restrict user accesses to image file without image authentication information added thereto.

20. The image capturing system according to claim 19, wherein the image capturing terminal is configured to prohibit user accesses to image file without image authentication information added thereto.

21. The image capturing system according to claim 19, wherein the image capturing terminal is configured to authorize accesses to image file without image authentication information added thereto only for the purpose of checking the images of the image file.

22. A progress information recording method of a program by an image capturing system comprising an image capturing terminal and a host computer, the method comprising:
the following to be carried out by the image capturing terminal:
capturing image data relating to the program;
transmitting image information relating to the image data to the host computer;
receiving the progress information relating to the progress of the program as transmitted from the host computer;
receiving the image authentication information as transmitted from the host computer; and
recording the image data with the received progress information and the received image authentication information added thereto; and
the following to be carried out by the host computer:
generating progress information of the program;
transmitting the progress information to the image capturing terminal;
receiving the image information as transmitted from the image capturing terminal;
generating image authentication information relating to the received image information; and
transmitting the image authentication information to the image capturing terminal.

23. The method according to claim 22, further including restricting user accesses to image data without image authentication information added thereto to be carried out by the image capturing terminal.

24. The method according to claim 23, wherein the restriction of accesses by the image capturing terminal includes prohibition of user accesses to image data without image authentication information.

25. The method according to claim 23, wherein the restriction of accesses by the image capturing terminal includes authorization of accesses to image data without image authentication information added thereto only for the purpose of checking the images of the image data.
